(19) United States
(12) Patent Application Publication
(10) Pub. No.: US 2011/0320953 A1
(43) Pub. Date: Dec. 29, 2011

(54) METHOD AND APPARATUS FOR PROJECTING A USER INTERFACE VIA PARTITION STREAMING

(75) Inventors: Qin Chen, Gainesville, FL (US); Raja Bose, Mountain View, CA (US); Jorg Brakensiek, Mountain View, CA (US)

(73) Assignee: NOKIA CORPORATION, Espoo (FI)

(21) Appl. No.: 12/970,508

(22) Filed: Dec. 16, 2010

Related U.S. Application Data
(60) Provisional application No. 61/287,910, filed on Dec. 18, 2009.

(51) Int. Cl. G06F 3/01

(52) U.S. Cl. 715/738

(57) ABSTRACT

Various methods for projecting a user interface via multiple encoded streams are provided. One example method includes generating first and at least second data streams. The data included in the first and second data streams may be configured to cause respective partitions of a unified user interface image to be displayed. The example method may also include generating fiducial information indicating at least a location for displaying the data of the first data streams on a display. The example method may also include causing the first data stream, the second data stream, and the fiducial information to be transmitted from an apparatus to a remote environment for displaying the first partition of the unified user interface image and the second partition of the unified user interface image on a display of the remote environment. Similar and related example methods and example apparatuses are also provided.

### TECHNICAL FIELD

Embodiments of the present invention relate generally to mobile device interoperability with a remote environment or remote client, and, more particularly, relate to a method and apparatus for projecting a user interface via partition streaming.

### BACKGROUND

Mobile computing devices continue to evolve such that the computing devices are capable of supporting new and powerful applications. Examples include location and mapping technologies (e.g., via Global Positioning System (GPS)), media player technologies (e.g., audio and video), web browsing technologies, gaming technologies, and the like. Mobile computing devices or mobile terminals, such as mobile phones, smart phones, personal digital assistants are evolving into personal media and entertainment centers in the sense that the devices are able to store and present a considerable amount of multimedia content. Moreover, many mobile computing devices support rich interactive games including those with three dimensional graphics.

However, due to the inherently small screen sizes and form factors of mobile computing devices, the user experience can be compromised when using rich applications. As such, solutions have been developed for interfacing a mobile computing device with a remote environment that, for example, includes a larger display. However, connecting a mobile computing device to a remote environment, such as a larger monitor or a device with a more convenient user interface often introduces latency to the user experience. Further, in many instances, modifications to the applications executed by the mobile computing devices are required to support use of a remote environment.

### BRIEF SUMMARY

Example methods and example apparatuses are described that provide for projecting a user interface using partitioned streaming. According to the various example embodiments, the use of streams associated with a portion of a user interface for projecting the user interface from a mobile terminal to a remote environment can reduce the latency and lag of the display of the remote environment in a manner that is application agnostic. According to various example embodiments, a presentation of a user interface (UI) can be separated into partitions of the user interface that may be separately coded. In this regard, user interface rendering may be separated, for example, into a partition for video content and a partition for UI controls (e.g., buttons, icons, etc.). Each of the partitions may be associated with data for presenting the partition on a display. The data for each partition may be forwarded, possibly without first decoding the data, to a remote environment via respective streams. According to some example embodiments, fiducial information may be generated that indicates to the remote environment where to place the user interface partitions upon displaying the user interface. In this regard, the remote environment may be configured to combine the data from the various streams, based on the fiducial information and display the user interface. A user may then interact with the remote environment to have a mobile terminal perform various functionalities. As a result of projecting the user interface in this manner, according to various example embodiments, the same or similar quality of interaction is achieved through the remote environment relative to the quality of interaction provided directly with the mobile terminal, and the projection of the user interface is accomplished in a manner that is application agnostic and requires low resource overhead.

Various example methods and apparatuses of the present invention are described herein, including example methods for projecting a user interface via partition streaming. One example method includes generating a first data stream, wherein the data included in the first data stream is configured to cause a first partition of a unified user interface image to be displayed, and generating at least a second data stream, wherein the data included in the second data stream is configured to cause a second partition of the unified user interface image to be displayed. The example method may also include generating, via a processor, fiducial information indicating at least a first location for displaying the data of the first data stream on a display, and causing the first data stream, the second data stream, and the fiducial information to be transmitted from an apparatus to a remote environment for displaying the first partition of the unified user interface image and the second partition of the unified user interface image on a display of the remote environment.

An additional example embodiment is an apparatus configured for projecting a user interface via partition streaming. The example apparatus comprises at least one processor and at least one memory including computer program code, the at least one memory and the computer program code configured to, with the at least one processor, cause the apparatus to perform various functionalities. The example apparatus may be configured to perform generating a first data stream, wherein the data included in the first data stream is configured to cause a first partition of a unified user interface image to be displayed, and generating at least a second data stream, wherein the data included in the second data stream is configured to cause a second partition of the unified user interface image to be displayed. The example apparatus may be further configured to perform generating fiducial information indicating at least a first location for displaying the data of the first data stream on a display, and causing the first data stream, the second data stream, and the fiducial information to be transmitted to a remote environment for displaying the first partition of the unified user interface image and the second partition of the unified user interface image on a display of the remote environment.

Another example embodiment is a computer-readable storage medium computer program code stored thereon, wherein execution of the computer program code causes an apparatus to perform various functionalities. Execution of the computer program code may cause an apparatus to perform generating a first data stream, wherein the data included in the first data stream is configured to cause a first partition of a unified user interface image to be displayed, and generating at least a second data stream, wherein the data included in the second data stream is configured to cause a second partition of the unified user interface image to be displayed. Execution of the computer program code may also cause an apparatus to perform generating fiducial information indicating at least a first location for displaying the data of the first data stream on a display, and causing the first data stream, the second data stream, and the fiducial information to be transmitted to a remote environment for displaying the first partition of the unified user interface image and the second partition of the unified user interface image on a display of the remote environment.

Yet another example embodiment is another example method. The example method may comprise receiving a first data stream from a device, wherein the data included in the first data stream is configured to cause a first partition of a unified user interface image to be displayed, and receiving at least a second data stream, wherein the data included in the second data stream is configured to cause a second partition of the unified user interface image to be displayed. The example method may further comprise receiving fiducial information indicating at least a first location for displaying the data of the first data stream on a display, and causing the unified user interface image to be displayed at a remote environment by combining, via a processor and based on the fiducial information, the data received via the first data stream with the data received via the second data stream.

Another example embodiment is an example apparatus comprising at least one processor and at least one memory including computer program code, the at least one memory and the computer program code configured to, with the at least one processor, cause the apparatus at least to perform various functionalities. The example apparatus may be configured to perform receiving a first data stream from a device, wherein the data included in the first data stream is configured to cause a first partition of a unified user interface image to be displayed, and receiving at least a second data stream, wherein the data included in the second data stream is configured to cause a second partition of the unified user interface image to be displayed. The example apparatus may be further configured to perform receiving fiducial information indicating at least a first location for displaying the data of the first data stream on a display, and causing the unified user interface image to be displayed at a remote environment by combining, based on the fiducial information, the data received via the first data stream with the data received via the second data stream.

Another example embodiment is a computer-readable storage medium computer program code stored thereon, wherein execution of the computer program code causes an apparatus to perform various functionalities. Execution of the computer program code may cause an apparatus to perform receiving a first data stream from a device, wherein the data included in the first data stream is configured to cause a first partition of a unified user interface image to be displayed, and receiving at least a second data stream, wherein the data included in the second data stream is configured to cause a second partition of the unified user interface image to be displayed. Execution of the computer program code may also cause an apparatus to perform receiving fiducial information indicating at least a first location for displaying the data of the first data stream on a display, and causing the unified user interface image to be displayed at a remote environment by combining, via a processor and based on the fiducial information, the data received via the first data stream with the data received via the second data stream.

Another example apparatus includes means for generating a first data stream, wherein the data included in the first data stream is configured to cause a first partition of a unified user interface image to be displayed, and means for generating at least a second data stream, wherein the data included in the second data stream is configured to cause a second partition of the unified user interface image to be displayed. The example apparatus may also include means for generating fiducial information indicating at least a first location for displaying the data of the first data stream on a display, and means for causing the first data stream, the second data stream, and the fiducial information to be transmitted from an apparatus to a remote environment for displaying the first partition of the unified user interface image and the second partition of the unified user interface image on a display of the remote environment.

Yet another example embodiment is another example apparatus. The example apparatus may include means for receiving a first data stream from a device, wherein the data included in the first data stream is configured to cause a first partition of a unified user interface image to be displayed, and means for receiving at least a second data stream, wherein the data included in the second data stream is configured to cause a second partition of the unified user interface image to be displayed. The example apparatus may further comprise means for receiving fiducial information indicating at least a first location for displaying the data of the first data stream on a display, and means for causing the unified user interface image to be displayed at a remote environment by combining, via a processor and based on the fiducial information, the data received via the first data stream with the data received via the second data stream.

### BRIEF DESCRIPTION OF THE DRAWING(S)

Having thus described the invention in general terms, reference will now be made to the accompanying drawings, which are not necessarily drawn to scale, and wherein:

FIG. 1 illustrates a system for projecting a user interface to remote environment according to an example embodiment of the present invention;

FIG. 2 illustrates a flow chart for the operation of a mobile terminal for projecting a user interface by streaming partition data according to an example embodiment of the present invention;

FIG. 3 illustrates a flow chart for the operation of a remote environment for projecting a user interface using partition streaming according to an example embodiment of the present invention;

FIG. 4 depicts a pictorial representation of a method for partitioning a user interface and transmitting the partitions via separate streams according to an example embodiment of the present invention;

FIG. 5 illustrates another flow chart for the operation of a remote environment for projecting a user interface using partition streaming according to an example embodiment of the present invention;

FIG. 6 illustrates a block diagram of an apparatus and associated system for transmitting partition streams to project a user interface according to an example embodiment of the present invention;

FIG. 7 illustrates a block diagram of a mobile terminal configured to transmit partition streams to project a user interface according to an example embodiment of the present invention;

FIG. 8 illustrates a flow chart of a method for receiving partition streams to project a user interface according to an example embodiment of the present invention;

FIG. 9 illustrates a block diagram of an apparatus and associated system for receiving partition streams to project a user interface according to an example embodiment of the present invention; and

FIG. 10 illustrates a flow chart of a method for generating and transmitting partition streams to project a user interface according to an example embodiment of the present invention.

### DETAILED DESCRIPTION

Example embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout. The terms “data,” “content,” “information,” and similar terms may be used interchangeably, according to some example embodiments of the present invention, to refer to data capable of being transmitted, received, operated on, and/or stored.

As used herein, the term ‘circuitry’ refers to all of the following: (a) hardware-only circuit implementations (such as implementations in only analog and/or digital circuitry); (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions); and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

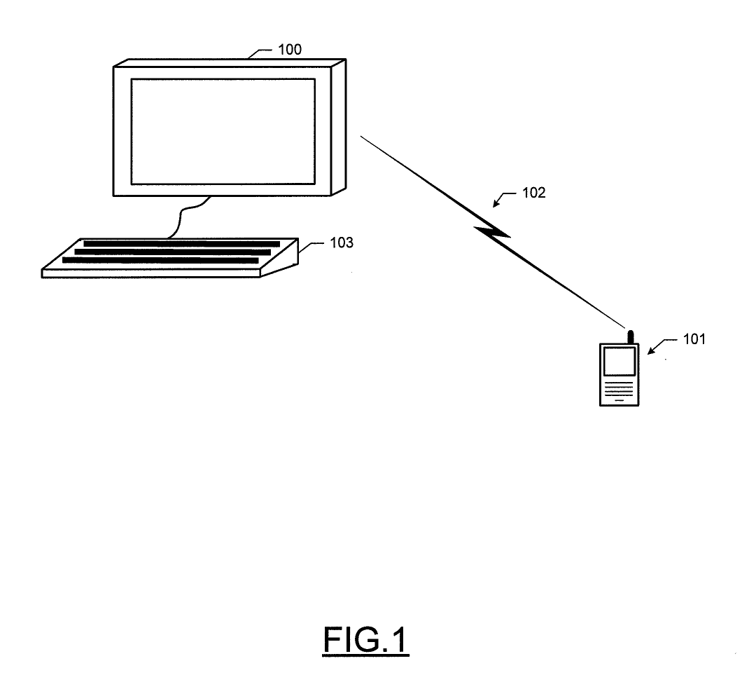

FIG. 1 illustrates an example system in accordance with various example embodiments of the present invention. The example system includes a remote environment 100, a mobile terminal 101, and a communications link 102.

The remote environment 100 may be any type of computing device configured to display an image. According to some example embodiments, the remote environment 100 may include user interface components and functionality. In this regard, keypad 103 may be an optional user input device. In some example embodiments, the remote environment 100 may include a touch screen display that is configured to receive input from a user via touch events with the display. Further, the remote environment 100 may include gaming controllers, speakers, a microphone, and the like. According to some example embodiments, the remote environment 100 may be a system of devices that define an intelligent space. The system of devices may be configured to cooperate to perform various functionalities. For example, a remote environment 100 implemented in a meeting room may include a large screen monitor, a wired telephone device, a computer, and the like. The remote environment 100 may also include a communications interface for communicating with the mobile terminal 101 via the communications link 102.

The communications link 102 may be any type communications link capable of supporting communications between the remote environment 100 and the mobile terminal 101. According to some example embodiments, the communications link 102 is a wireless local area network (WLAN) link. While the communications link 102 is depicted as a wireless link, it is contemplated that the communications link 102 may be a wired link.

The mobile terminal 101 may be any type of mobile computing and communications device. According to various example embodiments, the mobile terminal 101 is any type of user equipment. The mobile terminal 101 may be configured to communicate with the remote environment 100 via the communications link 102. The mobile terminal 101 may also be configured to execute and implement applications via a processor and memory included within the mobile terminal 101.

The interaction between the mobile terminal 101 and the remote environment 100 provides an example of mobile device interoperability, which may also be referred to as smart space, remote environment, and remote client. In this regard, features and capabilities of the mobile terminal 101 may be projected onto an external environment (e.g., the remote environment 100), and the external environment may appear as if the features and capabilities are inherent to external environment such that the dependency on the mobile terminal 101 is not apparent to a user. According to various example embodiments, the mobile terminal 101 may seamlessly become a part of the remote environment 100, whenever the person carrying the mobile device physically enters into the intelligent space (e.g., living room, meeting room, vehicle, or the like). The features and capabilities of the mobile terminal 101 may be projected onto the space (e.g., the remote environment 100) in manner that causes the features and capabilities to appear as if they are inherent to the space. Projecting the mobile terminal 101's features and capabilities may involve exporting the User Interface (UI) images of the mobile terminal 101, as well as command and control, to the external environment whereby, the user may comfortably interact with the external environment in lieu of the mobile terminal 101.

According to some example embodiments, the mobile terminal 101 may be configured to, via the communications connection 102, direct the remote environment 100 to project a user interface image originating with the mobile terminal 101 and receive user input provided via the remote environment 100. The image presented by the remote environment 100 may be the same image that is being presented on a display of the mobile terminal 101, or an image that would have been presented had the display of the mobile terminal 101 been activated. In some example embodiments, the image projected by the remote environment 100 may be a modified image, relative to the image that would have been provided on the display of the mobile terminal 101. For example, consider an example scenario where the remote environment 100 is installed in a vehicle as a vehicle head unit. The driver of the vehicle may wish to use the remote environment 100 as an interface to the mobile terminal 101 due, for example, to the convenient location of the remote environment 100 within the vehicle and the size of the display screen provided by the remote environment 100. The mobile terminal 101 may be configured to link with the remote environment 100, and direct the remote environment 100 to present user interface images. The mobile terminal 101 may provide data received by a frame buffer of the mobile terminal to the remote environment 100 via the communications link 102. The display frame buffer maybe a portion of contiguous memory in the mobile terminal 101 that stores information about each pixel in the display screen. The size of the display frame buffer may be equal to the product of the screen resolution with the number of bits required to store data for each pixel.

According to various example embodiments, the mobile terminal 101 may additionally or alternatively provide partition data streams to the remote environment 100 to facilitate projecting the user interface of the mobile terminal 101 onto the remote environment 100. Each of the data streams may be designated for a portion or partition of the user interface of the mobile terminal 101, and the data streams may include data encoded based on the type of information to be displayed. For example, a first data stream may include encoded video data for a video partition of the user interface, and a second data stream may include data for a controls partition of the user interface. According to some example embodiments, the partitions of the user interface may be associated with areas of the user interface that overlap. Upon receiving the two data streams, the remote environment 100 may be configured to combine data of the streams to project a unified user interface of the mobile terminal 101. Meta information or meta-data regarding the locations of the partitions on a display, which is a type of fiducial information, may be generated at the mobile terminal 101 and delivered to the remote environment 100, possibly embedded in one or more data streams. The remote environment 100 may use the fiducial information to combine the data received via the data streams to form a unified user interface image, and project the user interface image on the display of the remote environment 100. As such, in accordance with various example embodiments, the exact or similar look and feel of the mobile terminal's user interface may be recreated in the remote environment while delivering a smooth user experience. Additionally, in accordance with various example embodiments, the user interface is projected onto the remote environment in a manner that is application agnostic.

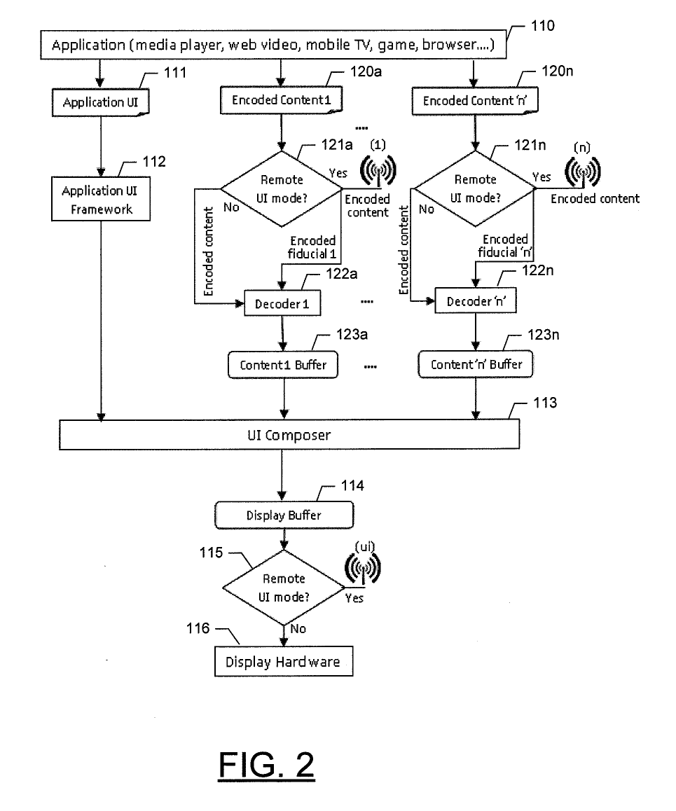

FIG. 2 illustrates a flowchart of an example method that may be implemented by a mobile terminal according to various example embodiments of the present invention. In this regard, the execution of an application (e.g., a media player, web video, mobile television, game browser, or the like) by the mobile terminal may be conducted at 110. Multimedia applications, such as media players, web video applications, mobile television applications and the like, may be built on top of a multimedia framework (MMF) and application development framework (ADF). MMF components may provide multimedia formatting and codecs for encoding and decoding specific types of contents (e.g., MP3, H.263, H.264, OpenGL (Open Graphics Library) etc.) for applications. ADF may provide applications with graphical user interface event services including windowing, layout management, and the like. Due to this type of framework, some or all portions, or partitions, of the user interface may be defined in respective segments of encoded content, such as video content encoded in H.264 or game graphics content as, for example, OpenGL or other types of graphics encoding. As such, the user interfaces for various applications may be partitioned based on segments of encoded content obtained or generated by the application.

The application at 110 may generate an application user interface at 111 that is configured in accordance with the application user interface framework 112, and provided to the user interface (UI) composer 113. The application may also obtain encoded content for the user interface and provide the encoded content to a respective decoder. However, in accordance with various example embodiments, when the mobile terminal is in a remote UI mode, that is, when the mobile terminal is currently supporting the projection of a user interface to a remote environment, the encoded content may be intercepted prior to being provided to a decoder, and streamed to the remote environment. In this regard, the application may obtain or generate multiple types of encoded content associated with the user interface. Any number of encoded portions of content may be obtained by the application. For example, referring to FIG. 2, encoded content 1 at 120a through encoded content ‘n’ at 120n may be obtained or generated.

A determination may be made at 121a through 121n (collectively or individually) as to whether the mobile terminal is in the remote UI mode. If the mobile terminal is not in the remote UI mode, the encoded content may be forwarded to respective decoders (e.g., decoders 122a through 122n). If the mobile terminal is currently in the remote UI mode, the encoded content may be transmitted as a separate stream to the remote environment. In this regard, if the mobile terminal is in the remote UI mode, the encoded content may be streamed to the remote environment, possibly after compressing and/or packetizing the encoded content. In another example embodiment, transcoding may also be performed prior to transmission of the data streams for a remote environment does not support the original encoding of the content.

Additionally, if the mobile terminal is in the remote UI mode, fiducial information for the respective encoded content may be obtained and transferred to the respective decoders (e.g., decoder 1 122a through decoder ‘n’ 122n) for decoding and subsequent storage in the respective content buffers (e.g., content 1 buffer 123a through content ‘n’ buffer 123n). The decoded fiducial information may then be provided to the UI composer 113.

Fiducial information may be used to inform the remote environment about parameters, such as the location and geometry of the associated content and how the content may be integrated into the resultant user interface of the remote environment. For example, fiducial information may be a chroma-key or other type of meta-data for indicating where the associated partition of the user interface should be rendered. In some example embodiments, the fiducial information may be provided in the form of an area marked with a specific solid color (e.g., green).

UI composer 113 may be configured to receive decoded data from each of the content buffers and the application UI framework 112, and layout a modified application UI with fiducial information describing the partitions associated with the streamed encoded content. The modified application UI may then be stored in the display buffer 114, which in some example embodiments may be a frame buffer. After the display buffer 114 is updated, and if the mobile terminal is in the remote UI mode, the modified application UI stored in the display buffer 114 may be streamed to the remote environment. According to some example embodiments, rather than including the fiducial information in the modified application UI stream, the fiducial information may be combined with the respective encoded content, possibly as meta-data. The data stored in the display buffer 114 may also be compressed or uncompressed, and/or exist in raw formats, such as 16 bits per pixel RGB565 or 32 bits per pixel RGB888. As stated above, the modified application UI stored in the display buffer 114 may also include the fiducial information corresponding to each encoded content stream, which are part of the mobile terminal's user interface.

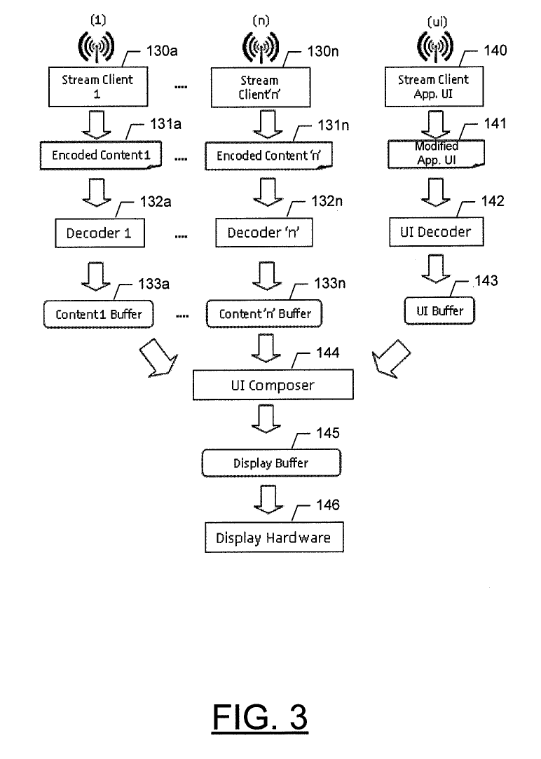

FIG. 3 illustrates a flowchart of the operations performed at the remote environment upon receipt of the data streams as described with respect to FIG. 2. In this regard, the remote environment may include stream clients (e.g., stream client 1 130a through stream client ‘n’ 130n, and stream client application UI 140) configured to receive each respective stream provided by a mobile terminal. Via the stream clients, the encoded content (e.g., encoded content 131a through 131n) may be received and the unified user interface content including the fiducial information (e.g., modified application UI 141) may be received. The encoded content and the modified application UI may be decoded, possibly after any pre-processing (e.g., uncompressing), by respective decoders (e.g., decoder 1 132a through decoder ‘n’ 132n, and UI decoder 142) and stored in respective buffers (e.g., content 1 buffer 133a through content ‘n’ buffer 133n, and UI buffer 143).

The UI composer 144 of the remote environment may then receive output from the decoders via the buffers as decoded content. The UI composer 144 may also be configured to determine the location and geometry of the partitions associated with the partitions of the encoded content in the display buffer 145. For example, if a chroma-key based fiducial information is used, then the UI composer 144 may be configured to analyze the areas which are colored with the chroma-key and associate the now decoded content the respective areas. According to some example embodiments, the UI composer 144 may be configured to match an identifier in the modified application IU with an identifier of the encoded content to place the decoded content in the proper location. In some example embodiments, the fiducial information may be embedded as meta-data in the stream and extracted by the UI composer 144 of the remote environment. After obtaining the location and geometry information, user interface frames can be then composed by combining the modified application UI with the decoded content to generate the final unified user interface, which may be stored in the display buffer 145. The remote environment display hardware 146 may then render the contents of the display buffer 145. According to some example embodiments, additional processing, including but not limited to, hardware or software scaling on decoded content frames may be performed when the geometry of original content on the mobile terminal is different from the geometry of the display area in the remote environment. Additionally, in some example embodiments, color space conversion may also be performed.

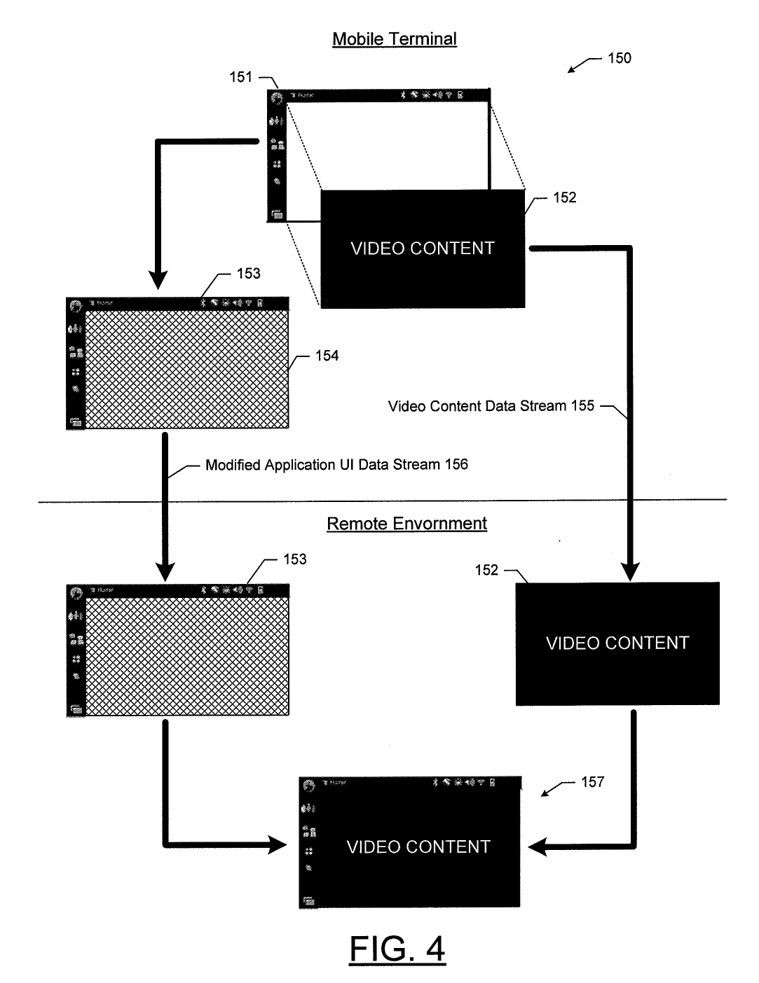

FIG. 4 illustrates a graphical representation of an example partition and combination of a user interface involving partition streaming. A user interface of a mobile terminal 150 may be separated into data associated with application controls 151 and data associated with a video content partition 152. To project the user interface 150 on a remote environment, the data associated with video content partition, which may or may not be encoded, may be separately streamed to the remote environment via the video content data stream 155. The mobile terminal may also be configured to generate the modified application UI 153, which may include a chroma-key region 154 associated with the location and geometry of the video content. The modified application UI 153 may be streamed to the remote environment via the modified application UI data stream 156. The remote environment may receive the modified application UI 153 and the data associated with the video content partition 152, and combine the modified application UI 153 with the data associated with the video content partition 152, based on the fiducial information in the form of a chroma-key, to form a unified user interface 157 for the remote environment.

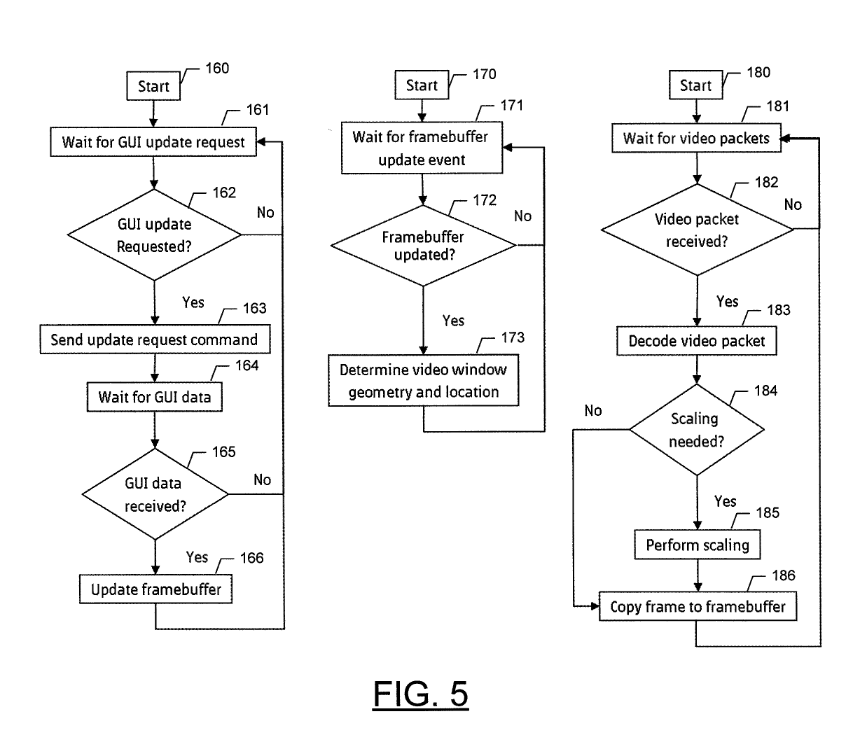

FIG. 5 provides another flowchart of an example method that may be performed by a remote environment. In this regard, a first portion of the method may begin at 160 and the remote environment may wait for a graphical user interface update request at 161. If no graphical user interface update request is received, the remote environment may continue to wait. When a graphical user interface update request is received, possibly from a component internal to the remote environment, the remote environment may send an update request command at 163. According to some example embodiments, the update request command may be received by a mobile terminal, and the mobile terminal may respond with graphical user interface data. Until the graphical user interface data is received, the remote environment may wait at 164. If graphical user interface data is not received at 165, the remote environment may revert back to waiting for a graphical user interface update request at 161. If the graphical user interface data is received at 165, which may include encoded data in a first stream and a modified application UI in another stream, the frame buffer may be updated at 166, generating a frame buffer update event, and the remote terminal may revert back to waiting for a graphical user interface update request at 161.

Within a second portion of the example method of FIG. 5, the example method may being at 170, and the remote environment may wait for a frame buffer update event at 171, and determine whether a frame buffer update event has occurred at 172. If a frame buffer update event does not occur, the remote environment may continue to wait for a frame buffer update event. If a frame buffer update event does occur, the video window geometry and location may be determined, for example, fiducial information.

Within a third portion of the example method of FIG. 5, the example method may begin at 180 and the remote environment may await a stream of video packets at 181. If video packets are not received at 182, the remote environment may continue to wait for video packets. If video packets are received, the video packets may be decoded at 183. At 184, determination may be made as to whether scaling is needed. If scaling is needed, then scaling may be performed at 185, and the resultant frame may be copied to the frame buffer of the remote environment at 186. If no scaling is needed, the frame may be copied to the frame buffer of the remote environment at 186. Upon copying the frame to the frame buffer, the remote environment may be configured to wait for additional video packets at 181.

Based on the forgoing description, particular use cases in accordance with example embodiments of the present invention may be considered. For example, consider a use case where the media player on the mobile terminal is current playing a video. In this case the mobile terminal UI that is being generated by the mobile terminal may be automatically split into two streams. The UI controls (e.g., buttons, task bars, etc.) may be streamed to the remote environment in an RGB format, whereas the video content may be streamed to the remote environment in an H.264 format. The two streams may be received by the remote environment and combined utilizing fiducial information, possibly in the form of meta-data, which is embedded in either or both of the streams. In this manner, according to various example embodiments, the exact or a similar look-and-feel of the mobile terminal UI may be projected on the remote environment while delivering a smooth user experience.

Another example use case involves a mobile device implementing a three-dimensional game. The user may have connected the mobile terminal to a large screen television for playing the game via the television. Game controllers may be included in the remote environment that includes the television. The mobile terminal UI may be automatically split into two streams. The UI controls (e.g., buttons, task bars, etc.) may be streamed to the remote environment in an RGB format, whereas the three-dimensional graphics elements may be streamed to the remote environment as OpenGL-ES rendering commands. The remote environment may then render the three-dimensional graphics using the OpenGL-ES commands and combine the result with the RGB UI stream. As a result, according to various example embodiments, the user is thereby provided with both a superior and seamless gaming experience.

According to another example embodiment, the original user interface of, for example, a mobile terminal may be projected to multiple remote environments. In this regard, for example, a data stream of encoded video may be transmitted to a remote environment that is a television. Another data stream that includes the UI controls of the user interface may be transmitted to another remote environment, for example, to a remote control configured to display and support the controls. Each remote environment may be configured, as described herein, to project the associated portion of the user interface.

Accordingly, various example embodiments of the present invention can perform application agnostic projecting of a user interface on a remote environment. According to some example embodiments, no change in existing applications is required to implement user interface partition streaming. By partitioning the mobile terminal UI into multiple streams, which might include transmitting compressed encoded data, such as video, or rendering commands, such as OpenGL, various example embodiments may achieve full frame rate high quality video playback and/or graphics can be achieved even for high definition displays with only a relatively moderate communication bandwidth requirement between mobile terminal and the remote environment. Some example embodiments are also beneficial for saving processing resources and power consumption on the mobile terminal, since the decoding task is shifted to the remote environment.

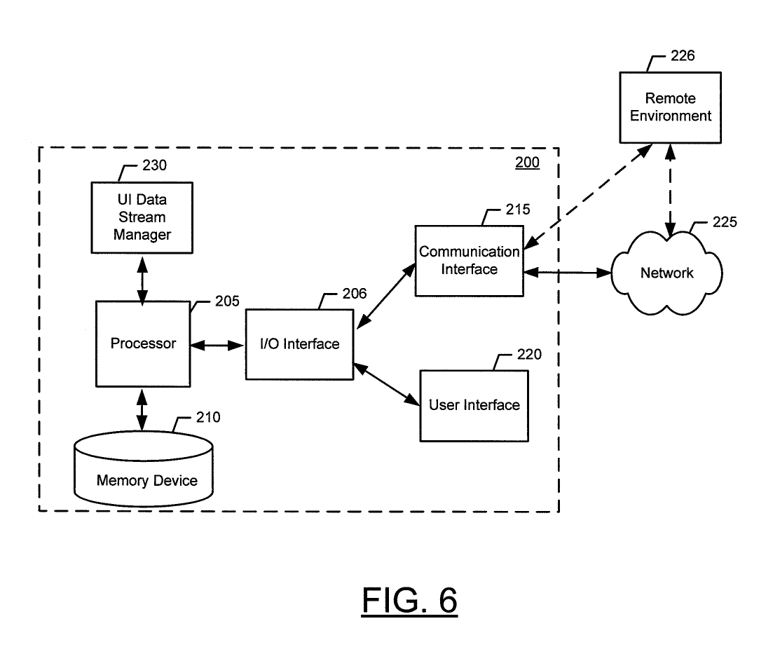

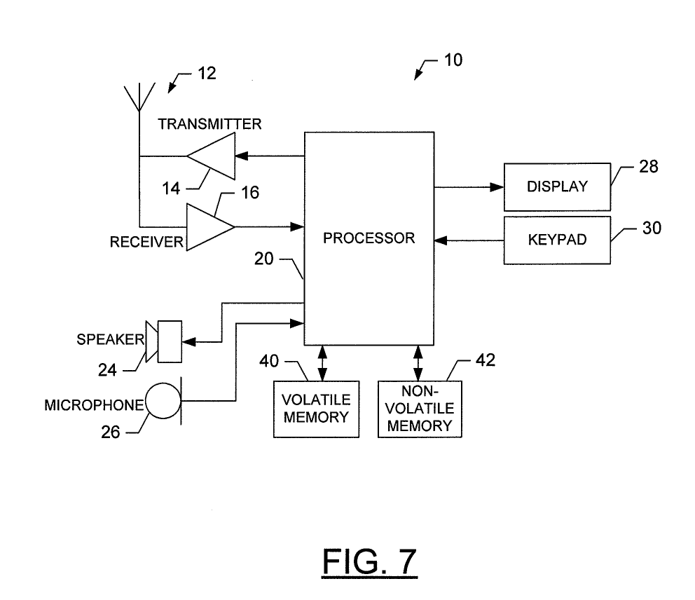

The description provided above and generally herein illustrates example methods, example apparatuses, and example computer program products for projecting a user interface via multiple streams. FIG. 6 depicts an example apparatus that is configured to perform various functionalities from the perspective of a mobile terminal as described with respect to FIGS. 1 and 2, and as generally described herein. FIG. 7 depicts another example apparatus in the form of a specific mobile terminal that may be configured to operate as described with respect to FIGS. 1 and 2, and as generally described herein. The example apparatuses depicted in FIGS. 6 and 7 may also be configured to perform example methods of the present invention, such as those described with respect to FIGS. 2-5 and 8.

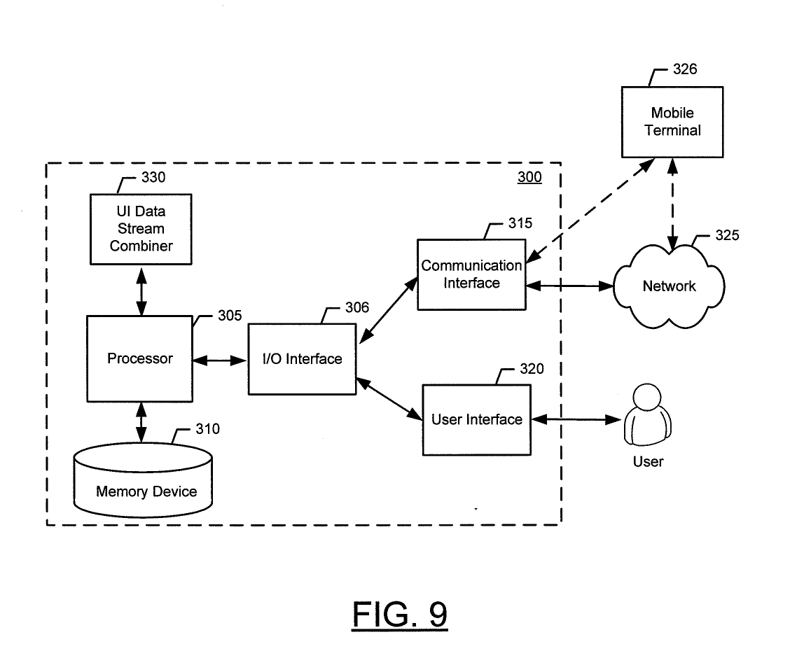

FIG. 9 depicts an example apparatus that is configured to perform various functionalities from the perspective of a remote environment as described with respect to FIGS. 1, 2, 4, and 8, and as generally described herein. The example apparatus 300 of FIG. 9 may also be configured to perform example methods of the present invention, such as those described with respect to FIGS. 3-5 and 10.

Referring now to FIG. 6, in some example embodiments, the apparatus 200 may, be embodied as, or included as a component of, a communications device with wired or wireless communications capabilities. In some example embodiments, the apparatus 200 may be part of a communications device, such as a stationary or a mobile terminal. As a mobile terminal, the apparatus 200 may be a mobile computer, mobile telephone, a portable digital assistant (PDA), a pager, a mobile television, a gaming device, a camera, a video recorder, an audio/video player, a radio, and/or a global positioning system (GPS) device, any combination of the aforementioned, or the like. Regardless of the type of communications device, apparatus 200 may also include computing capabilities.

The example apparatus 200 includes or is otherwise in communication with a processor 205, a memory device 210, an Input/Output (I/O) interface 206, a communications interface 215, user interface 220, and a UI Data Stream Manager 230. The processor 205 may be embodied as various means for implementing the various functionalities of example embodiments of the present invention including, for example, a microprocessor, a coprocessor, a controller, a special-purpose integrated circuit such as, for example, an ASIC (application specific integrated circuit), an FPGA (field programmable gate array), or a hardware accelerator, processing circuitry or the like. According to one example embodiment, processor 205 may be representative of a plurality of processors, or one or more multiple core processors, operating in concert. Further, the processor 205 may be comprised of a plurality of transistors, logic gates, a clock (e.g., oscillator), other circuitry, and the like to facilitate performance of the functionality described herein. The processor 205 may, but need not, include one or more accompanying digital signal processors. In some example embodiments, the processor 205 is configured to execute instructions stored in the memory device 210 or instructions otherwise accessible to the processor 205. The processor 205 may be configured to operate such that the processor causes the apparatus 200 to perform various functionalities described herein.

Whether configured as hardware or via instructions stored on a computer-readable storage medium, or by a combination thereof, the processor 205 may be an entity capable of performing operations according to embodiments of the present invention while configured accordingly. Thus, in example embodiments where the processor 205 is embodied as, or is part of, an ASIC, FPGA, or the like, the processor 205 is specifically configured hardware for conducting the operations described herein. Alternatively, in example embodiments where the processor 205 is embodied as an executor of instructions stored on a computer-readable storage medium, the instructions specifically configure the processor 205 to perform the algorithms and operations described herein. In some example embodiments, the processor 205 is a processor of a specific device (e.g., a mobile terminal) configured for employing example embodiments of the present invention by further configuration of the processor 205 via executed instructions for performing the algorithms, methods, and operations described herein.

The memory device 210 may be one or more computer-readable storage media that may include volatile and/or non-volatile memory. In some example embodiments, the memory device 210 includes Random Access Memory (RAM) including dynamic and/or static RAM, on-chip or off-chip cache memory, and/or the like. Further, memory device 210 may include non-volatile memory, which may be embedded and/or removable, and may include, for example, read-only memory, flash memory, magnetic storage devices (e.g., hard disks, floppy disk drives, magnetic tape, etc.), optical disc drives and/or media, non-volatile random access memory (NVRAM), and/or the like. Memory device 210 may include a cache area for temporary storage of data. In this regard, some or all of memory device 210 may be included within the processor 205.

Further, the memory device 210 may be configured to store information, data, applications, computer-readable program code instructions, and/or the like for enabling the processor 205 and the example apparatus 200 to carry out various functions in accordance with example embodiments of the present invention described herein. For example, the memory device 210 could be configured to buffer input data for processing by the processor 205. Additionally, or alternatively, the memory device 210 may be configured to store instructions for execution by the processor 205.

The I/O interface 206 may be any device, circuitry, or means embodied in hardware, software, or a combination of hardware and software that is configured to interface the processor 205 with other circuitry or devices, such as the communications interface 215 and the user interface 220. In some example embodiments, the processor 205 may interface with the memory 210 via the I/O interface 206. The I/O interface 206 may be configured to convert signals and data into a form that may be interpreted by the processor 205. The I/O interface 206 may also perform buffering of inputs and outputs to support the operation of the processor 205. According to some example embodiments, the processor 205 and the I/O interface 206 may be combined onto a single chip or integrated circuit configured to perform, or cause the apparatus 200 to perform, various functionalities of the present invention.

The communication interface 215 may be any device or means embodied in either hardware, a computer program product, or a combination of hardware and a computer program product that is configured to receive and/or transmit data from/to a network 225 and/or any other device or module in communication with the example apparatus 200 (e.g., remote environment 226). In this regard, according to various example embodiments, the apparatus 200, via the communications interface 215 may either directly connect with the remote environment 226 (e.g., via Bluetooth) or connect to the remote environment via the network 225. The connection between the remote environment 226 and the apparatus 200 may be wired or wireless. Processor 205 may also be configured to facilitate communications via the communications interface by, for example, controlling hardware included within the communications interface 215. In this regard, the communication interface 215 may include, for example, one or more antennas, a transmitter, a receiver, a transceiver and/or supporting hardware, including, for example, a processor for enabling communications. Via the communication interface 215, the example apparatus 200 may communicate with various other network entities in a device-to-device fashion and/or via indirect communications via a base station, access point, server, gateway, router, or the like.

The communications interface 215 may be configured to provide for communications in accordance with any wired or wireless communication standard. The communications interface 215 may be configured to support communications in multiple antenna environments, such as multiple input multiple output (MIMO) environments. Further, the communications interface 215 may be configured to support orthogonal frequency division multiplexed (OFDM) signaling. In some example embodiments, the communications interface 215 may be configured to communicate in accordance with various techniques, such as, second-generation (2G) wireless communication protocols, IS-136 (time division multiple access (TDMA)), GSM (global system for mobile communication), IS-95 (code division multiple access (CDMA)), third-generation (3G) wireless communication protocols, such as Universal Mobile Telecommunications System (UMTS), CDMA2000, wideband CDMA (WCDMA) and time division-synchronous CDMA (TD-SCDMA), 3.9 generation (3.9G) wireless communication protocols, such as Evolved Universal Terrestrial Radio Access Network (E-UTRAN), with fourth-generation (4G) wireless communication protocols, international mobile telecommunications advanced (IMT-Advanced) protocols, Long Term Evolution (LTE) protocols including LTE-advanced, or the like. Further, communications interface 215 may be configured to provide for communications in accordance with techniques such as, for example, radio frequency (RF), infrared (IrDA) or any of a number of different wireless networking techniques, including WLAN techniques such as IEEE 802.11 (e.g., 802.11a, 802.11b, 802.11g, 802.11n, etc.), wireless local area network (WLAN) protocols, world interoperability for microwave access (WiMAX) techniques such as IEEE 802.16, and/or wireless Personal Area Network (WPAN) techniques such as IEEE 802.15, BlueTooth (BT), low power versions of BT, ultra wideband (UWB), Wibree, Zigbee and/or the like. The communications interface 215 may also be configured to support communications at the network layer, possibly via Internet Protocol (IP).

The user interface 220 may be in communication with the processor 205 to receive user input via the user interface 220 and/or to present output to a user as, for example, audible, visual, mechanical or other output indications. The user interface 220 may include, for example, a keyboard, a mouse, a joystick, a display (e.g., a touch screen display), a microphone, a speaker, or other input/output mechanisms. Further, the processor 205 may comprise, or be in communication with, user interface circuitry configured to control at least some functions of one or more elements of the user interface. The processor 205 and/or user interface circuitry may be configured to control one or more functions of one or more elements of the user interface through computer program instructions (e.g., software and/or firmware) stored on a memory accessible to the processor 205 (e.g., volatile memory, non-volatile memory, and/or the like). In some example embodiments, the user interface circuitry is configured to facilitate user control of at least some functions of the apparatus 200 through the use of a display and configured to respond to user inputs. The processor 205 may also comprise, or be in communication with, display circuitry configured to display at least a portion of a user interface, the display and the display circuitry configured to facilitate user control of at least some functions of the apparatus 200.

The UI data stream manager 230 of example apparatus 200 may be any means or device embodied, partially or wholly, in hardware, a computer program product, or a combination of hardware and a computer program product, such as processor 205 implementing stored instructions to configure the example apparatus 200, memory device 210 storing executable program code instructions configured to carry out the functions described herein, or a hardware configured processor 205 that is configured to carry out the functions of the UI data stream manager 230 as described herein. In an example embodiment, the processor 205 includes, or controls, the UI data stream manager 230. The UI data stream manager 230 may be, partially or wholly, embodied as processors similar to, but separate from processor 205. In this regard, the UI data stream manager 230 may be in communication with the processor 205. In various example embodiments, the UI data stream manager 230 may, partially or wholly, reside on differing apparatuses such that some or all of the functionality of the UI data stream manager 230 may be performed by a first apparatus, and the remainder of the functionality of the UI data stream manager 230 may be performed by one or more other apparatuses.

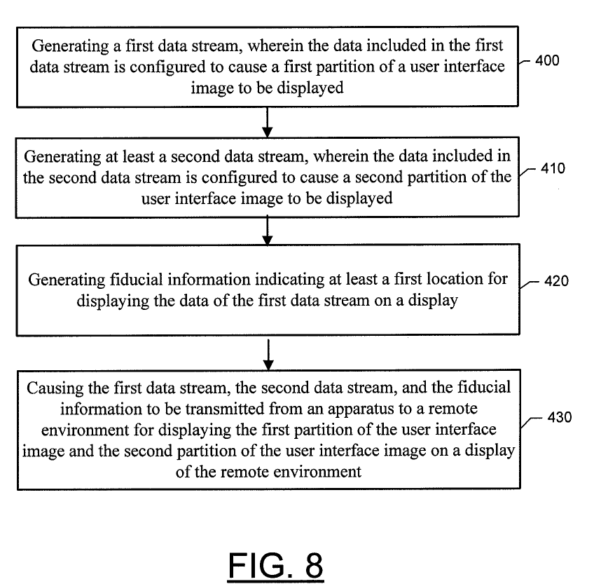

The apparatus 200 and the processor 205 may be configured to perform the following functionality via the UI data stream manager 230. In this regard, the UI data stream manager 230 may be configured to cause the processor 205 and/or the apparatus 200 to perform various functionalities, such as those depicted in the flowchart of FIG. 8. The UI data stream manager 230 may be configured to generate a first data stream at 400 and generate at least a second data stream at 410. The first and/or second data streams may include data configured to cause a respective first and/or second partition of a user interface image to be displayed. According to some example embodiments, the first and/or second data stream may include encoded data, or the first and/or second data streams may be generated based on encoded data (e.g., the data streams may include compressed, encoded data). In some example embodiments, the data of the first and/or second data stream may be encoded video data, such as data encoded in the H.264 format. According to some example embodiments, the UI data stream manager 230 and/or the apparatus 200 obtains encoded user interface image data (e.g., from memory) and does not decode the data, but rather generates the first and/or second data streams from the encoded user interface data and forwards the encoded data within the first and/or second data streams to the remote environment 226. In this regard, the data for the first and/or second data streams may be intercepted within the apparatus 200 prior to decoding and forwarded to a remote environment 226, without having decoded the data. According to some example embodiments, the first data stream may include data encoded in accordance with a first format and the second data stream may include data encoded in a second format, where the first and second formats are different.

The UI data stream manager 230 may also be configured to generate fiducial information at 420. The fiducial information may be configured to indicate a first location for displaying the data of the data stream on a display. The fiducial may also indicate a second location for displaying the data of the second data stream on a display. Further, the UI data stream manager 230 may also be configured to cause the first data stream, the second data stream, and the fiducial information to be transmitted (e.g., via the communications interface 215), at 430, to a remote environment 226 for displaying the first partition and at least the second partition of the user interface image on a display of the remote environment 226. The data may be transmitted in a manner that permits a user to interact with the apparatus 200 and/or processor 205 by providing user input to the remote environment 226. Further, the fiducial information may be included in one of the data streams, for example as meta-data. Also, according to some example embodiments, the fiducial information may be formatted as a chroma-key.

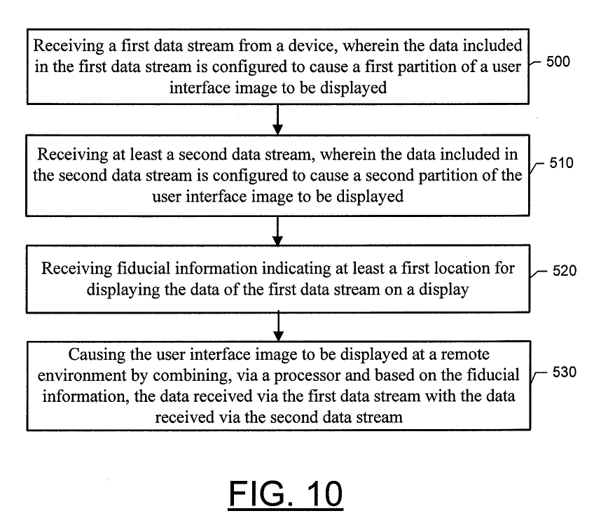

Referring now to FIG. 7, a more specific example apparatus in accordance with various embodiments of the present invention is provided. The example apparatus of FIG. 10 is a mobile terminal 10 configured to communicate within a wireless network, such as a cellular communications network. The mobile terminal 10 may be configured to perform the functionality of the mobile terminal 101 and/or apparatus 200 as described herein. More specifically, the mobile terminal 10 may be caused to perform the functionality of the UI data stream manager 230 via the processor 20. In this regard, processor 20 may be an integrated circuit or chip configured similar to the processor 205 together with, for example, the I/O interface 206. Further, volatile memory 40 and non-volatile memory 42 may configured to support the operation of the processor 20 as computer readable storage media.

The mobile terminal 10 may also include an antenna 12, a transmitter 14, and a receiver 16, which may be included as parts of a communications interface of the mobile terminal 10. The speaker 24, the microphone 26, the display 28, and the keypad 30 may be included as parts of a user interface.

Referring now to FIG. 9, the apparatus 300 may, be embodied as, or included as a component of, a communications device with wired or wireless communications capabilities. In some example embodiments, the apparatus 300 may be part of a communications device, such as remote environment as described herein. As a remote environment, the apparatus 300 may be any type of device that may interface with another device for projecting a user interface, such as, a television, a monitor, a projector, a vehicle (e.g., automobile or airplane) information and/or entertainment console, a computer, a mobile telephone, a gaming device, a mobile computer, a laptop computer, a camera, a video recorder, an audio/video player, a radio, and/or a global positioning system (GPS) device, any combination of the aforementioned, or the like. Regardless of the type of communications device, apparatus 300 may also include computing capabilities.

The example apparatus 300 includes or is otherwise in communication with a processor 305, a memory device 310, an Input/Output (I/O) interface 306, a communications interface 315, user interface 320, and a UI data stream combiner 330. The processor 305 may be embodied as various means for implementing the various functionalities of example embodiments of the present invention including, for example, a microprocessor, a coprocessor, a controller, a special-purpose integrated circuit such as, for example, an ASIC (application specific integrated circuit), an FPGA (field programmable gate array), or a hardware accelerator, processing circuitry or the like. According to one example embodiment, processor 305 may be representative of a plurality of processors, or one or more multiple core processors, operating in concert. Further, the processor 305 may be comprised of a plurality of transistors, logic gates, a clock (e.g., oscillator), other circuitry, and the like to facilitate performance of the functionality described herein. The processor 305 may, but need not, include one or more accompanying digital signal processors. In some example embodiments, the processor 305 is configured to execute instructions stored in the memory device 310 or instructions otherwise accessible to the processor 305. The processor 305 may be configured to operate such that the processor causes the apparatus 300 to perform various functionalities described herein.

Whether configured as hardware or via instructions stored on a computer-readable storage medium, or by a combination thereof, the processor 305 may be an entity capable of performing operations according to embodiments of the present invention while configured accordingly. Thus, in example embodiments where the processor 305 is embodied as, or is part of, an ASIC, FPGA, or the like, the processor 305 is specifically configured hardware for conducting the operations described herein. Alternatively, in example embodiments where the processor 305 is embodied as an executor of instructions stored on a computer-readable storage medium, the instructions specifically configure the processor 305 to perform the algorithms and operations described herein. In some example embodiments, the processor 305 is a processor of a specific device (e.g., a remote environment) configured for employing example embodiments of the present invention by further configuration of the processor 305 via executed instructions for performing the algorithms, methods, and operations described herein.

The memory device 310 may be one or more computer-readable storage media that may include volatile and/or non-volatile memory. In some example embodiments, the memory device 310 includes Random Access Memory (RAM) including dynamic and/or static RAM, on-chip or off-chip cache memory, and/or the like. Further, memory device 310 may include non-volatile memory, which may be embedded and/or removable, and may include, for example, read-only memory, flash memory, magnetic storage devices (e.g., hard disks, floppy disk drives, magnetic tape, etc.), optical disc drives and/or media, non-volatile random access memory (NVRAM), and/or the like. Memory device 310 may include a cache area for temporary storage of data. In this regard, some or all of memory device 310 may be included within the processor 305.

Further, the memory device 310 may be configured to store information, data, applications, computer-readable program code instructions, and/or the like for enabling the processor 305 and the example apparatus 300 to carry out various functions in accordance with example embodiments of the present invention described herein. For example, the memory device 310 could be configured to buffer input data for processing by the processor 305. Additionally, or alternatively, the memory device 310 may be configured to store instructions for execution by the processor 305.

The I/O interface 306 may be any device, circuitry, or means embodied in hardware, software, or a combination of hardware and software that is configured to interface the processor 305 with other circuitry or devices, such as the communications interface 315 and the user interface 320. In some example embodiments, the processor 305 may interface with the memory 310 via the I/O interface 306. The I/O interface 306 may be configured to convert signals and data into a form that may be interpreted by the processor 305. The I/O interface 306 may also perform buffering of inputs and outputs to support the operation of the processor 305. According to some example embodiments, the processor 305 and the I/O interface 306 may be combined onto a single chip or integrated circuit configured to perform, or cause the apparatus 300 to perform, various functionalities of the present invention.

The communication interface 315 may be any device or means embodied in either hardware, a computer program product, or a combination of hardware and a computer program product that is configured to receive and/or transmit data from/to a network 325 and/or any other device or module in communication with the example apparatus 300 (e.g., mobile terminal 326). In this regard, according to various example embodiments, the apparatus 300, via the communications interface 315 may either directly connect with the mobile terminal 326 (e.g., via Bluetooth) or connect to the mobile terminal via the network 325. The connection between the mobile terminal 326 and the apparatus 300 may be wired or wireless. Processor 305 may also be configured to facilitate communications via the communications interface by, for example, controlling hardware included within the communications interface 315. In this regard, the communication interface 315 may include, for example, one or more antennas, a transmitter, a receiver, a transceiver and/or supporting hardware, including, for example, a processor for enabling communications. Via the communication interface 315, the example apparatus 300 may communicate with various other network entities in a device-to-device fashion and/or via indirect communications via a base station, access point, server, gateway, router, or the like.

The communications interface 315 may be configured to provide for communications in accordance with any wired or wireless communication standard. The communications interface 315 may be configured to support communications in multiple antenna environments, such as multiple input multiple output (MIMO) environments. Further, the communications interface 315 may be configured to support orthogonal frequency division multiplexed (OFDM) signaling. In some example embodiments, the communications interface 315 may be configured to communicate in accordance with various techniques, such as, second-generation (2G) wireless communication protocols, IS-136 (time division multiple access (TDMA)), GSM (global system for mobile communication), IS-95 (code division multiple access (CDMA)), third-generation (3G) wireless communication protocols, such as Universal Mobile Telecommunications System (UMTS), CDMA3000, wideband CDMA (WCDMA) and time division-synchronous CDMA (TD-SCDMA), 3.9 generation (3.9G) wireless communication protocols, such as Evolved Universal Terrestrial Radio Access Network (E-UTRAN), with fourth-generation (4G) wireless communication protocols, international mobile telecommunications advanced (IMT-Advanced) protocols, Long Term Evolution (LTE) protocols including LTE-advanced, or the like. Further, communications interface 315 may be configured to provide for communications in accordance with techniques such as, for example, radio frequency (RF), infrared (IrDA) or any of a number of different wireless networking techniques, including WLAN techniques such as IEEE 802.11 (e.g., 802.11a, 802.11b, 802.11g, 802.11n, etc.), wireless local area network (WLAN) protocols, world interoperability for microwave access (WiMAX) techniques such as IEEE 802.16, and/or wireless Personal Area Network (WPAN) techniques such as IEEE 802.15, BlueTooth (BT), low power versions of BT, ultra wideband (UWB), Wibree, Zigbee and/or the like. The communications interface 315 may also be configured to support communications at the network layer, possibly via Internet Protocol (IP).

The user interface 320 may be in communication with the processor 305 to receive user input via the user interface 320 and/or to present output to a user as, for example, audible, visual, mechanical or other output indications. The user interface 320 may include, for example, a keyboard, a mouse, a joystick, a display (e.g., a touch screen display), a microphone, a speaker, or other input/output mechanisms. Further, the processor 305 may comprise, or be in communication with, user interface circuitry configured to control at least some functions of one or more elements of the user interface. The processor 305 and/or user interface circuitry may be configured to control one or more functions of one or more elements of the user interface through computer program instructions (e.g., software and/or firmware) stored on a memory accessible to the processor 305 (e.g., volatile memory, non-volatile memory, and/or the like). In some example embodiments, the user interface circuitry is configured to facilitate user control of at least some functions of the apparatus 300 through the use of a display and configured to respond to user inputs. The processor 305 may also comprise, or be in communication with, display circuitry configured to display at least a portion of a user interface, the display and the display circuitry configured to facilitate user control of at least some functions of the apparatus 300.

The UI data stream combiner 330 of example apparatus 300 may be any means or device embodied, partially or wholly, in hardware, a computer program product, or a combination of hardware and a computer program product, such as processor 305 implementing stored instructions to configure the example apparatus 300, memory device 310 storing executable program code instructions configured to carry out the functions described herein, or a hardware configured processor 305 that is configured to carry out the functions of the UI data stream combiner 330 as described herein. In an example embodiment, the processor 305 includes, or controls, the UI data stream combiner 330. The UI data stream combiner 330 may be, partially or wholly, embodied as processors similar to, but separate from processor 305. In this regard, the UI data stream combiner 330 may be in communication with the processor 305. In various example embodiments, the UI data stream combiner 330 may, partially or wholly, reside on differing apparatuses such that some or all of the functionality of the UI data stream combiner 330 may be performed by a first apparatus, and the remainder of the functionality of the UI data stream combiner 330 may be performed by one or more other apparatuses.

The apparatus 300 and the processor 305 may be configured to perform the following functionality via the UI data stream combiner 330. In this regard, the UI data stream combiner 330 may be configured to cause the processor 305 and/or the apparatus 300 to perform various functionalities, such as those depicted in the flowchart of FIG. 10. The UI data stream combiner 330 may be configured to receive a first data stream at 500 and receive at least a second data stream at 510. The first and/or second data streams may include data configured to cause a respective first and/or second partition of a user interface image to be displayed. According to some example embodiments, the first and/or second data streams may include encoded data or compressed, encoded data. In some example embodiments, the data of the first and/or second data stream may be encoded video data, such as data encoded in the H.264 format. According to some example embodiments, the UI data stream combiner 330 and/or the apparatus 300 receives the encoded data within the first and/or second data streams from the mobile terminal 326. According to some example embodiments, the first data stream may include data encoded in accordance with a first format and the second data stream may include data encoded in a second format, where the first and second formats are different.

The UI data stream combiner 330 may also be configured to receive fiducial information at 520. The fiducial information may be configured to indicate a first location for displaying the data of the data stream on a display. The fiducial may also indicate a second location for displaying the data of the second data stream on a display. According to some example embodiments, the fiducial information may be included in one of the data streams. Further, the UI data stream combiner 330 may also be configured to cause a user interface image to be displayed (e.g., via the user interface 320) by combining, based on the fiducial information, the data received via the first data stream with the data received via at least the second data stream. The displaying the user interface image may permit a user to interact with the mobile terminal 326 by providing user input to the user interface 320 of the apparatus 300.

FIGS. 2-5, 8 and 10 illustrate flowcharts of example systems, methods, and/or computer program products according to example embodiments of the invention. It will be understood that each operation of the flowcharts, and/or combinations of operations in the flowcharts, can be implemented by various means. Means for implementing the operations of the flowcharts, combinations of the operations in the flowchart, or other functionality of example embodiments of the present invention described herein may include hardware, and/or a computer program product including a computer-readable storage medium (as opposed to a computer-readable transmission medium which describes a propagating signal) having one or more computer program code instructions, program instructions, or executable computer-readable program code instructions stored therein. In this regard, program code instructions may be stored on a memory device, such as memory device 210 or 310, of an example apparatus, such as example apparatus 200 or 300, and executed by a processor, such as the processor 205 or 305. As will be appreciated, any such program code instructions may be loaded onto a computer or other programmable apparatus (e.g., processor 205 or 305, memory device 210 or 310, or the like) from a computer-readable storage medium to produce a particular machine, such that the particular machine becomes a means for implementing the functions specified in the flowcharts' operations. These program code instructions may also be stored in a computer-readable storage medium that can direct a computer, a processor, or other programmable apparatus to function in a particular manner to thereby generate a particular machine or particular article of manufacture. The instructions stored in the computer-readable storage medium may produce an article of manufacture, where the article of manufacture becomes a means for implementing the functions specified in the flowcharts' operations. The program code instructions may be retrieved from a computer-readable storage medium and loaded into a computer, processor, or other programmable apparatus to configure the computer, processor, or other programmable apparatus to execute operations to be performed on or by the computer, processor, or other programmable apparatus. Retrieval, loading, and execution of the program code instructions may be performed sequentially such that one instruction is retrieved, loaded, and executed at a time. In some example embodiments, retrieval, loading and/or execution may be performed in parallel such that multiple instructions are retrieved, loaded, and/or executed together. Execution of the program code instructions may produce a computer-implemented process such that the instructions executed by the computer, processor, or other programmable apparatus provide operations for implementing the functions specified in the flowcharts' operations.

Accordingly, execution of instructions associated with the operations of the flowchart by a processor, or storage of instructions associated with the blocks or operations of the flowcharts in a computer-readable storage medium, support combinations of operations for performing the specified functions. It will also be understood that one or more operations of the flowcharts, and combinations of blocks or operations in the flowcharts, may be implemented by special purpose hardware-based computer systems and/or processors which perform the specified functions, or combinations of special purpose hardware and program code instructions.

Additional example embodiments of the present invention are described as follows. An example method may comprise generating a first data stream, wherein the data included in the first data stream is configured to cause a first partition of a unified user interface image to be displayed, and generating at least a second data stream, wherein the data included in the second data stream is configured to cause a second partition of the unified user interface image to be displayed. The example method may also include generating, via a processor, fiducial information indicating at least a first location for displaying the data of the first data stream on a display, and causing the first data stream, the second data stream, and the fiducial information to be transmitted from an apparatus to a remote environment for displaying the first partition of the unified user interface image and the second partition of the unified user interface image on a display of the remote environment. In some example embodiments, causing the first data stream, the second data stream, and the fiducial information to be transmitted to a remote environment includes interfacing with the remote environment in a manner that permits a user to interact with the apparatus via the remote environment. In some example embodiments, generating the first data stream includes generating the first data stream based on encoded data. In some example embodiments, generating the first data stream includes generating the first data stream based on encoded video or graphic data. In some example embodiments, generating the first data stream includes generating the first data stream based on data having a first type of encoding, and generating the second data stream includes generating the second data stream based on data having a second type of encoding, the first and second types of encoding being different. In some example embodiments, generating the first data stream includes generating the first data stream based on data having a first type of encoding, wherein the data having the first type of encoding is not decoded at the apparatus. According to some example embodiments, generating the second data stream comprises including the fiducial information in the data transmitted via the second data stream, and wherein the fiducial data is a chroma-key.

Another example embodiment is an example apparatus. The example apparatus comprises at least one processor and at least one memory including computer program code, the at least one memory and the computer program code configured to, with the at least one processor, cause the apparatus to perform various functionalities. The example apparatus may be configured to perform generating a first data stream, wherein the data included in the first data stream is configured to cause a first partition of a unified user interface image to be displayed, and generating at least a second data stream, wherein the data included in the second data stream is configured to cause a second partition of the unified user interface image to be displayed. The example apparatus may be further configured to perform generating fiducial information indicating at least a first location for displaying the data of the first data stream on a display, and causing the first data stream, the second data stream, and the fiducial information to be transmitted to a remote environment for displaying the first partition of the unified user interface image and the second partition of the unified user interface image on a display of the remote environment. In some example embodiments, the example apparatus configured to perform causing the first data stream, the second data stream, and the fiducial information to be transmitted to a remote environment includes being configured to perform interfacing with the remote environment in a manner that permits a user to interact with the apparatus via the remote environment. In some example embodiments, the example apparatus configured to perform generating the first data stream includes being configured to perform generating the first data stream based on encoded data. In some example embodiments, the example apparatus configured to perform generating the first data stream includes being configured to perform generating the first data stream based on encoded video or graphic data. In some example embodiments, the example apparatus configured to perform generating the first data stream includes being configured to perform generating the first data stream based on data having a first type of encoding, and wherein the example apparatus configured to perform generating the second data stream includes being configured to perform generating the second data stream based on data having a second type of encoding, the first and second types of encoding being different. In some example embodiments, the example apparatus configured to perform generating the first data stream includes being configured to perform generating the first data stream based on data having a first type of encoding, wherein the data having the first type of encoding is not decoded at the apparatus. According to some example embodiments, generating the second data stream comprises including the fiducial information in the data transmitted via the second data stream, and wherein the fiducial data is a chroma-key.

Another example embodiment is a computer-readable storage medium computer program code stored thereon, wherein execution of the computer program code causes an apparatus to perform various functionalities. Execution of the computer program code may cause an apparatus to perform generating a first data stream, wherein the data included in the first data stream is configured to cause a first partition of a unified user interface image to be displayed, and generating at least a second data stream, wherein the data included in the second data stream is configured to cause a second partition of the unified user interface image to be displayed. Execution of the computer program code may also cause an apparatus to perform generating fiducial information indicating at least a first location for displaying the data of the first data stream on a display, and causing the first data stream, the second data stream, and the fiducial information to be transmitted to a remote environment for displaying the first partition of the unified user interface image and the second partition of the unified user interface image on a display of the remote environment.

Yet another example embodiment is another example method. The example method may comprise receiving a first data stream from a device, wherein the data included in the first data stream is configured to cause a first partition of a unified user interface image to be displayed, and receiving at least a second data stream, wherein the data included in the second data stream is configured to cause a second partition of the unified user interface image to be displayed. The example method may further comprise receiving fiducial information indicating at least a first location for displaying the data of the first data stream on a display, and causing the unified user interface image to be displayed at a remote environment by combining, via a processor and based on the fiducial information, the data received via the first data stream with the data received via the second data stream. According to some example embodiments, causing the unified user interface image to be displayed at the remote environment includes interfacing the remote environment with the device in a manner that permits a user to interact with the device via the remote environment. According to some example embodiments, receiving the first data stream includes receiving the first data stream as encoded data. According to some example embodiments, receiving the first data stream includes receiving the first data stream as encoded video or graphic data. According to some example embodiments, receiving the first data stream includes receiving the first data stream, the data of the first data stream having a first type of encoding, and receiving the second data stream includes receiving the second data stream, the data of the second data stream having a first type of encoding, the first and second types of encoding being different.

Another example embodiment is an example apparatus comprising at least one processor and at least one memory including computer program code, the at least one memory and the computer program code configured to, with the at least one processor, cause the apparatus at least to perform various functionalities. The example apparatus may be configured to perform receiving a first data stream from a device, wherein the data included in the first data stream is configured to cause a first partition of a unified user interface image to be displayed, and receiving at least a second data stream, wherein the data included in the second data stream is configured to cause a second partition of the unified user interface image to be displayed. The example apparatus may be further configured to perform receiving fiducial information indicating at least a first location for displaying the data of the first data stream on a display, and causing the unified user interface image to be displayed at a remote environment by combining, based on the fiducial information, the data received via the first data stream with the data received via the second data stream. According to some example embodiments, the example apparatus configured to perform causing the unified user interface image to be displayed at the remote environment includes being configured to perform interfacing the remote environment with the device in a manner that permits a user to interact with the device via the remote environment. According to some example embodiments, the example apparatus configured to perform receiving the first data stream includes being configured to perform receiving the first data stream as encoded data. According to some example embodiments, the example apparatus configured to perform receiving the first data stream includes being configured to perform receiving the first data stream as encoded video or graphic data. According to some example embodiments, the example apparatus configured to perform receiving the first data stream includes being configured to perform receiving the first data stream, the data of the first data stream having a first type of encoding; and wherein the apparatus configured to perform receiving the second data stream includes being configured to perform receiving the second data stream, the data of the second data stream having a first type of encoding, the first and second types of encoding being different.

Another example embodiment is a computer-readable storage medium computer program code stored thereon, wherein execution of the computer program code causes an apparatus to perform various functionalities. Execution of the computer program code may cause an apparatus to perform receiving a first data stream from a device, wherein the data included in the first data stream is configured to cause a first partition of a unified user interface image to be displayed, and receiving at least a second data stream, wherein the data included in the second data stream is configured to cause a second partition of the unified user interface image to be displayed. Execution of the computer program code may also cause an apparatus to perform receiving fiducial information indicating at least a first location for displaying the data of the first data stream on a display, and causing the unified user interface image to be displayed at a remote environment by combining, via a processor and based on the fiducial information, the data received via the first data stream with the data received via the second data stream.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions other than those explicitly described above are also contemplated as may be set forth in some of the appended claims. Although specific terms are employed herein, they are used in a generic and descriptive sense only and not for purposes of limitation.

What is claimed is:

1. A method comprising:
generating a first data stream, wherein the data included in the first data stream is configured to cause a first partition of a unified user interface image to be displayed;
generating at least a second data stream, wherein the data included in the second data stream is configured to cause a second partition of the unified user interface image to be displayed;
generating, via a processor, fiducial information indicating at least a first location for displaying the data of the first data stream on a display; and
causing the first data stream, the second data stream, and the fiducial information to be transmitted from an apparatus to a remote environment for displaying the first partition of the unified user interface image and the second partition of the unified user interface image on a display of the remote environment.

2. The method of claim 1, wherein causing the first data stream, the second data stream, and the fiducial information to be transmitted to a remote environment includes interfacing with the remote environment in a manner that permits a user to interact with the apparatus via the remote environment.

3. The method of claim 1, wherein generating the first data stream includes generating the first data stream based on encoded data.

4. The method of claim 1, wherein generating the first data stream includes generating the first data stream based on at least one of encoded video and graphic data.

5. The method of claim 1, wherein generating the first data stream includes generating the first data stream based on data having a first type of encoding; and wherein generating the second data stream includes generating the second data stream based on data having a second type of encoding, the first and second types of encoding being different.

6. The method of claim 1, wherein generating the first data stream includes generating the first data stream based on data having a first type of encoding, wherein the data having the first type of encoding is not decoded at the apparatus.

7. The method of claim 1, wherein generating the second data stream comprises including the fiducial information in the data transmitted via the second data stream, and wherein the fiducial data is a chroma key.

8. An apparatus comprising at least one processor and at least one memory including computer program code, the at least one memory and the computer program code configured to, with the at least one processor, cause the apparatus at least to perform:
generating a first data stream, wherein the data included in the first data stream is configured to cause a first partition of a unified user interface image to be displayed;
generating at least a second data stream, wherein the data included in the second data stream is configured to cause a second partition of the unified user interface image to be displayed;
generating fiducial information indicating at least a first location for displaying the data of the first data stream on a display; and
causing the first data stream, the second data stream, and the fiducial information to be transmitted to a remote environment for displaying the first partition of the unified user interface image and the second partition of the unified user interface image on a display of the remote environment.

9. The apparatus of claim 8, wherein the apparatus configured to perform causing the first data stream, the second data stream, and the fiducial information to be transmitted to a remote environment includes being configured to perform interfacing with the remote environment in a manner that permits a user to interact with the apparatus via the remote environment.

10. The apparatus of claim 8, wherein the apparatus configured to perform generating the first data stream includes being configured to perform generating the first data stream based on encoded data.

11. The apparatus of claim 8, wherein the apparatus configured to perform generating the first data stream includes being configured to perform generating the first data stream based on at least one encoded video and graphic data.

12. The apparatus of claim 8, wherein the apparatus configured to perform generating the first data stream includes being configured to perform generating the first data stream based on data having a first type of encoding; and wherein the apparatus configured to perform generating the second data stream includes being configured to perform generating the second data stream based on data having a second type of encoding, the first and second types of encoding being different.

13. The apparatus of claim 8, wherein the apparatus configured to perform generating the first data stream includes being configured to perform generating the first data stream based on data having a first type of encoding, wherein the data having the first type of encoding is not decoded at the apparatus.

14. The apparatus of claim 8, wherein the apparatus configured to perform generating the second data stream includes being caused to perform including the fiducial information in the data transmitted via the second data stream, and wherein the fiducial data is a chroma key.

15. The apparatus of claim 8, wherein the apparatus comprises a mobile terminal.

16. The apparatus of claim 15, wherein the apparatus comprises a communications interface configured to transmit the first data stream, the second data stream, and the fiducial information to the remote environment.

17. A computer-readable storage medium having computer program code stored thereon, wherein execution of the computer program code directs an apparatus to:
generate a first data stream, wherein the data included in the first data stream is configured to cause a first partition of a unified user interface image to be displayed;
generate at least a second data stream, wherein the data included in the second data stream is configured to cause a second partition of the unified user interface image to be displayed;
generate fiducial information indicating at least a first location for displaying the data of the first data stream on a display; and
cause the first data stream, the second data stream, and the fiducial information to be transmitted to a remote environment for displaying the first partition of the unified user interface image and the second partition of the unified user interface image on a display of the remote environment.

18. The computer-readable storage medium of claim 17, wherein the computer program code that directs the apparatus to cause the first data stream, the second data stream, and the fiducial information to be transmitted to a remote environment includes computer program code that directs the apparatus to interface with the remote environment in a manner that permits a user to interact with the apparatus via the remote environment.

19. The computer-readable storage medium of claim 17, wherein the computer program code that directs the apparatus to generate the first data stream includes computer program code that directs the apparatus to generate the first data stream based on encoded data.

20. The computer-readable storage medium of claim 17, wherein the computer program code that directs the apparatus to generate the first data stream includes computer program code that directs the apparatus to generate the first data stream based on at least one of encoded video and graphic data.
